(19) United States
(12) Patent Application Publication
(10) Pub. No.: US 2010/0140286 A1
(43) Pub. Date: Jun. 10, 2010

(54) PORTABLE BEVERAGE MACHINE

(76) Inventor: Michael Christopher Quinn, Tampa, FL (US)

Correspondence Address: CARLSON, GASKEY & OLDS, P.C., 400 WEST MAPLE ROAD, SUITE 350, BIRMINGHAM, MI, 48009, US

(21) Appl. No.: 12/330,137

(22) Filed: Dec. 8, 2008

(51) Int. Cl. G07F 11/00; F25B 27/00; F25D 23/00; G07F 9/10

(52) U.S. Cl. 221/150 R; 62/236; 62/259.1; 221/1

(57) ABSTRACT

The beverage vending machine comprises a beverage storage area, a mechanism to dispense beverages, a solar photovoltaic panel, a battery, and a refrigeration unit. The energy gathered by the solar photovoltaic panel is stored within the battery, and a self-contained refrigeration unit is operable to cool the beverage storage area. The beverage vending machine operates without an external source of electricity.

### BACKGROUND OF THE INVENTION

This invention relates to a system that can dispense beverage containers to customers. More particularly, the machine can be operated without an external source of electricity.

Vending machines, and especially beverage machines, commonly require electricity from an electrical outlet in order to be operated. This severely limits the areas where the machine could be used. Some vending machines utilize solar photovoltaic panels to convert sunlight into electricity, with this electricity being used to power the machine. While allowing for more portable use, this design lacks refrigeration, and therefore, it is not possible to distribute cold beverages with this device.

Another vending machine utilizes compressed gas to power pistons, and operation of the device is purely mechanical. The gas can also be emitted as a refrigerant fluid, and this fluid is used to cool items before ejecting them. Because this device does not use electricity, many desirable features, like a paper money collector, cannot be used. In addition, since the compressed gas provides all mechanical power and refrigeration, it cannot be conserved in a cycle, and therefore must be frequently replaced when depleted.

### SUMMARY OF THE INVENTION

In one embodiment, the beverage vending machine comprises a beverage storage area, a mechanism to dispense beverages, a solar photovoltaic panel, a battery, and a refrigeration unit. Energy gathered by the solar photovoltaic panel is stored in the battery, and the refrigeration unit is operable to cool the beverage storage area.

In one embodiment, the beverage vending machine comprises a beverage storage area, a mechanism to dispense beverages, a solar photovoltaic panel, a battery, and a refrigeration unit, wherein the refrigeration unit uses an ammonia absorption refrigeration cycle. Energy gathered by the solar photovoltaic panel is stored in the battery, and the refrigeration unit is operable to cool the beverage storage area. If enough energy is available the boiler in the refrigeration unit can be powered by the battery, however the boiler can also be powered by internal combustion within the refrigeration unit.

The beverage vending machine of the present invention can therefore be placed at almost any location, without being connected to an electrical outlet. The machine could be placed outdoors temporarily for festivals, concerts, sporting events, etc. The machine could be placed at work sites to provide beverages to the workers, where electricity could not be practically provided to a vending machine. The present invention greatly expands the locations at which beverage vending machines could be provided.

These and other features of the present invention can be best understood from the following specification and drawings, the following of which is a brief description.

### BRIEF DESCRIPTION OF THE DRAWINGS

FIG. 1 schematically illustrates an example beverage vending machine of the present invention

FIG. 2 schematically illustrates an example ammonia absorption refrigeration cycle of the present invention

### DETAILED DESCRIPTION OF A PREFERRED EMBODIMENT

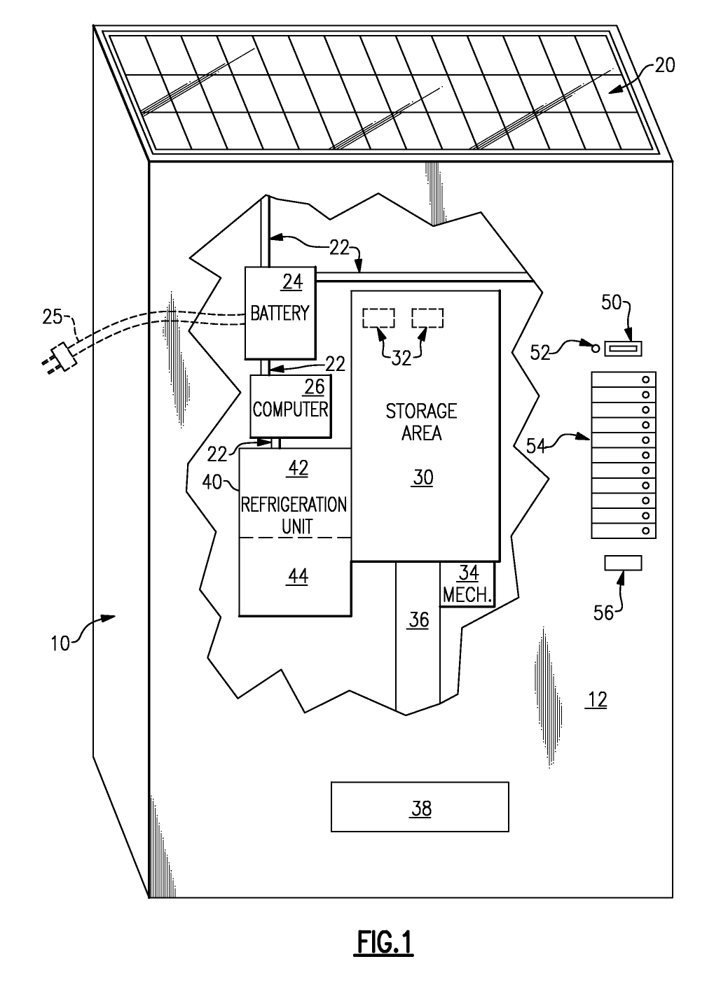

FIG. 1 schematically illustrates an example beverage vending machine 10 according to one embodiment of the present invention. The beverage vending machine 10 includes a casing 12. Located on the outside of the casing 12 is a solar photovoltaic panel 20. Energy gathered from the solar photovoltaic panel 20 is transferred via electrical connectors 22 to a battery 24. The battery 24 connects to and powers a computer 26 via electrical connectors 22. The battery 24 could be lead acid, lithium ion, a hydrogen fuel cell or other electricity storage technology. An optional electrical cord 25, such as the type for plugging into a standard 110 volt or 220 volt outlet may also be provided for pre-cooling the vending machine 10 prior to delivery to the sales area, or for use when such an outlet is available.

The beverage vending machine 10 includes a beverage storage area 30. Located with the beverage storage area 30 are beverage containers 32, such as cans, bottles, etc. A mechanism 34, powered by the battery 24 and controlled by the computer 26, functions to dispense the beverage containers. To dispense, the mechanism 34 transports a beverage container 32 to a track 36. The beverage container 32 travels down the track 36, where it exits the casing 12 via a dispensing area 38. From the dispensing area 38, the beverage container 32 may be retrieved by the customer. The dispensing mechanism 34 may include a trap door, corkscrew, pusher arm or any other known devices for selectively releasing an item in a vending machine after payment. Beverages may also be stored in storage area 30 without individual beverage containers, e.g. “fountain” beverages (e.g. syrup, water and CO2 gas).

The beverage storage area 30 can be maintained at a cool temperature via a refrigeration unit 40. The refrigeration unit 40 is controlled by the computer 26, and may include a first cooling system 42 and a second cooling system 44 (or only one of the first cooling system 42 and second cooling system 44) connected to the computer 26 by connectors 22. The first cooling system 42 receives power from the battery 24. The second cooling system 44 is not electric, and will be explained more below.

To operate the beverage vending machine, money can be inserted into a currency acceptor 50. A beverage selection is then made on a selection panel 54 or other user input device. Change can be returned to the customer at a change receptacle 56. If the customer would like a refund of his money before a beverage is selected, he may press a refund button 52, and the money will be returned to the change receptacle 56. The currency acceptor 50 and selection panel 54 are powered by the battery 24 via electrical connectors 22. The currency acceptor 50 and selection panel 54 are controlled by the computer 26.

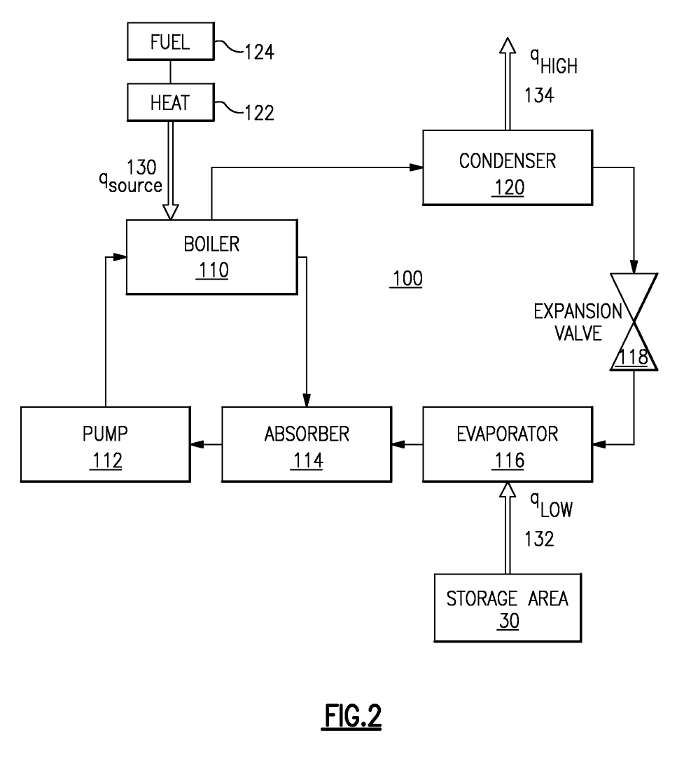

FIG. 2 schematically illustrates an example ammonia absorption refrigeration cycle 100 that could be used as the refrigeration unit 44 in FIG. 1. Heat energy q_{Source} 130 is transferred into a boiler 110. The heat energy q_{Source} 130 can be supplied either electrically (if there is sufficient electricity being provided by the solar photovoltaic panel 20) or from internal combustion such as by a flame or other heat 122 consuming a fuel 124, such as propane, natural gas, or any fuel, in a storage tank. Heat 122 can also be provided by solar or other energy. High pressure ammonia vapor is transferred from the boiler 110 to a condenser 120, while weak ammonia solution is returned from the boiler 110 to an absorber 114. In the condenser 120, heat energy q_{High} 134 is released to the ambient. From the condenser 120, liquid ammonia is sent to an expansion valve 118. The liquid ammonia continues from the expansion valve 118 to an evaporator 116. Heat energy q_{Low} 132 is transferred from the cold space (storage area 30) into the evaporator 116. Low pressure ammonia vapor from the evaporator 116 is sent to the absorber 114, where it mixes with weak ammonia solution from the boiler 110. The resulting mixture is a strong ammonia solution, which moves from the absorber 114 to the pump 112. The pump 112 pumps the strong ammonia solution to the boiler 110, where the cycle begins again.

The ammonia absorption refrigeration cycle 100 is given as an example, but other types of non-electric cooling systems could also be used as the cooling system 42, such as other flame-powered (or even using solar heating instead of flame-heating) refrigeration systems using other fuels and other refrigerants. In operation, if there is enough electricity being provided by the solar photovoltaic panel 20, and the battery 24 is already charged, the computer 26 provides electric power to run the first cooling system 42. If there is not enough electricity being provided by the solar photovoltaic panel 20, or if this electricity is being used to charge the battery 24, then the computer 26 controls the second cooling system 44 to provide the cooling to the storage area 30. Operation of the non-electric second cooling system 44 consumes the fuel 124, so to the extent that the electric first cooling system 42 can be used, this will extend the time before the fuel 124 needs to be refilled.

As indicated above, the use of two cooling systems 42, 44 is optional. The beverage vending machine 10 could just include the non-electric second cooling system 44 and not the electric first cooling system 42, although the addition of the electric first cooling system 42 may extend the time before refueling.

Additionally, the inclusion of the electric first cooling system 42 also provides the ability to pre-cool the storage area before delivery to the sales location via external electrical power (e.g. 110 volt supply) supplied via an electrical cord 25.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A beverage vending machine comprising:
a beverage storage area;
a dispensing mechanism to dispense beverages from the beverage storage area;
a solar photovoltaic panel;
a battery, wherein energy gathered by the solar photovoltaic panel is stored within the battery, the battery powering the dispensing mechanism and
a refrigeration unit, wherein the refrigeration unit is operable to cool the beverage storage area without electricity.

2. The beverage vending machine of claim 1, wherein the refrigeration unit uses an ammonia absorption refrigeration cycle.

3. The beverage vending machine of claim 2, wherein the ammonia absorption refrigeration cycle is powered by internal combustion.

4. The beverage vending machine of claim 1, wherein the refrigeration unit is also operable to cool the beverage storage area with electricity.

5. The beverage vending machine of claim 1 further including a plurality of beverage containers in the beverage storage area.

6. A beverage vending machine comprising:
a beverage storage area;
a dispensing mechanism to dispense beverage from the beverage storage area;
a solar photovoltaic panel;
a battery, wherein energy gathered by the solar photovoltaic panel is stored within the battery;
a refrigeration unit, wherein the refrigeration unit is operable to cool the beverage storage area;
a computer, wherein the computer is powered by the battery, and wherein the computer controls the dispensing mechanism to dispense beverages and the refrigeration unit;
a currency acceptor, wherein the currency acceptor is powered by the battery, and wherein the currency acceptor is controlled by the computer; and
a selection panel for the selection of beverages, wherein the selection panel sends a user selection to the computer.

7. The beverage vending machine of claim 6, wherein the refrigeration unit uses an ammonia absorption refrigeration cycle.

8. The beverage vending machine of claim 6, wherein the refrigeration unit may be powered by electricity from the battery.

9. The beverage vending machine of claim 7, wherein the ammonia absorption refrigeration cycle may be powered by internal combustion.

10. A method for dispensing beverage including the steps of:
generating electricity from a solar cell;
storing the electricity from the solar cell;
powering a user input device for selecting a beverage;
cooling a plurality of beverages in a storage area without electricity; and
selectively dispensing at least one of the beverages from the storage area based upon an input from the user input device.

11. The method of claim 10 wherein the step of cooling the plurality of beverages includes the step of using an ammonia absorption refrigeration cycle.

12. The method of claim 10 wherein the step of cooling the plurality of beverages includes the step of combusting a fuel.
